(19) United States
(12) Patent Application Publication
(10) Pub. No.: US 2010/0190677 A1
(43) Pub. Date: Jul. 29, 2010

(54) LAUNDRY MULTI-COMPARTMENT POUCH COMPOSITION

(75) Inventors: Andrea Esposito, Rome (IT); Vincenzo Guida, Rome (IT); Carlo Ricci, Rome (IT); Luca Sarcinelli, Rome (IT)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/694,493

(22) Filed: Jan. 27, 2010

(30) Foreign Application Priority Data
Jan. 28, 2009 (EP) 09151484.4
Dec. 10, 2009 (EP) 09178683.0

(51) Int. Cl. C11D 17/00

(52) U.S. Cl. 510/296

(57) ABSTRACT

Laundry multi-compartment pouch made from a water-soluble film and having at least two compartments. The pouch of the present invention comprises a composition containing a solid component and a liquid component, wherein the solid component contains a peroxide source and a mixture of specific polymer.

### FIELD OF THE INVENTION

This invention relates to laundry pouch made from a water-soluble film and having at least two compartments, containing a solid component and a liquid component, wherein the solid phase contains a peroxide source and a specific combination of polymers.

### BACKGROUND TO THE INVENTION

Laundry detergent products and bleaching compositions based on peroxygen oxygen bleaches, nowadays, come in a number of various product forms, such as granules, liquids and tablets. Each forms having its advantages and disadvantages, which gives the consumer a large choice of products they can use. Unitised doses of detergents and bleaching compositions are found to be more and more attractive and convenient to consumers. Indeed, this “unit dose” are easy to handle and avoid the need of the consumer to measure the product, thereby giving rise to a more precise dosing and avoiding wasteful overdosing or under-dosing.

Bleaching compositions in form of a pouch form are especially known in the art, as they have the advantage over tablets of avoiding the contact of the consumer fingers with the bleach compositions. However, the inclusion of bleach, such as percarbonate salts in compositions in form a pouch, has been restricted hitherto by the relative instability of the bleach.

Indeed, it is well known that bleaches, such sodium percarbonate lose its available oxygen at a significant rate in the presence of ions of heavy metals such as iron, copper and manganese and especially in the presence of moisture. Furthermore, percarbonate decomposition due to moisture becomes more of an issue during storage as laundry treatment products are often stored in humid environments where the product picks up moisture.

Therefore, there has been much activity in view of increasing percarbonate stability so as to obtain a viable component of detergent formulations.

Composition comprising an alkali metal salt of percarbonate and with a dry-form composition comprising a polymer, has been used in view of solving this moisture and stability problem. See for example EP 0572724A1 (published the 08.12.1993) which discloses percarbonate particles which are stabilized by means of close physical contact with certain polymers. Pouches for detergents as such are also known in the art to be useful to provide unit dose compositions and to separate ingredients from one another. For example, EP 1283862A1 (published the 02.19.2003) or EP 1262539A1 (published the 04.12.2002) relate to a multi-compartment pouch made from a water-soluble film and having at least two compartments.

However, the use of such polymers has the disadvantages of creating formulae and compositions which are sticky and which are not flowable, essentially during the process of production. Flowability properties for compositions, have always been a requirement for composition; especially in view of obtaining a less sticky and cohesive product. This property is essential in view of having an optimum process of production. Indeed, the less sticky and cohesive the product is, easier it is to produce and fill the pouches.

It is therefore an object of the present invention to provide a multi-compartment pouches, comprising bleaches, having improved stability both upon the manufacture and the storage of said dry laundry bleaching composition. It is another object of the present invention to have, in the same time, a multi-compartment pouches with good dissolution profile and good bleaching performance.

It has now been found that these objectives can be met by formulating a composition, in a laundry multi-compartment pouch, which comprises a bleach together with a combination of specific polymers, as described hereinafter.

An advantage of the present invention is thus to provide a bleaching composition incorporating alkali metal percarbonate bleach displaying improved stability, in which the percarbonate bleach does not require complex protection techniques.

A further advantage of the present invention is thus to have a laundry multi-compartment pouch which have excellent bleaching performance, especially on bleachable soils/stains such as tea; fruit juice and coloured vegetable soils which still being safe to fabric.

Another advantage of the present invention is that laundry multi-compartment pouch has good solubility and minimum gelling and therefore maximum delivery of the detergent components to the wash. These benefits lead to good washing performance and minimising of any fabric damage due to high localised bleach concentrations.

### SUMMARY OF THE INVENTION

The present invention relates to a bleach additive composition in a pouch, which can be used to bleach fabrics in conjunction with a conventional granular or liquid laundry detergent. More specifically, the present invention relates to a laundry multi-compartment pouch made from a water-soluble film and having at least two compartments. The pouch of the present invention comprises a composition containing a solid component and a liquid component, wherein the solid component contains:
i. from 60 to 95% of a peroxide source;
ii. from 1 to 30% of a polymer A which is a polyacrylate or polycarboxylate;
iii. from 1 to 30% of a polymer B which is according to formula I:

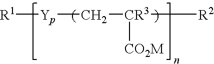

wherein Y is a comonomer or comonomer mixture selected from the group consisting of maleic acid, citraconic acid, itaconic acid, mesaconic acid and salts thereof and mixtures thereof as the first monomer, and an unsaturated monocarboxylic acid such as acrylic acid or an alpha —C₁₋₄ alkyl acrylic acid as second monomer; R¹ and R² are bleach- and alkali-stable polymer-end groups; R³ is H, OH or C₁₋₄ alkyl; M is H, alkali metal, alkaline earth metal, ammonium or substituted ammonium; p is not 0, up to 2; and n is at least 10, or mixtures thereof.
   wherein, the weight ratio of polymer B to polymer A is comprised between 0.033 and 30, and the total polymer concentration is between 1 and 30% by weight of the solid component.

The present invention also relates to a method for treating laundry by placing the pouch, according to the present invention, in the drum of the washing machine.

### BRIEF DESCRIPTION OF THE DRAWING

FIG. 1 illustrates the hygroscopy and the flowability of the pouch of the present invention according to the weight ratio of Polymer B to Polymer A (ratio Polymer B/Polymer A).

### DETAILED DESCRIPTION OF THE INVENTION

The present invention relates to a bleach additive composition in a pouch, which can be used to bleach fabrics in conjunction with a conventional granular or liquid laundry detergent.

### The Pouch

The multi-compartment pouch, according to the present invention, comprises a composition containing a solid component and a liquid component, wherein the first compartment comprises a liquid component and wherein the second compartment comprises a solid component.

The multi-compartment pouch of the invention, herein referred to as “pouch”, comprises at least two compartments. The pouch herein is typically a closed structure, made of materials described herein, enclosing a volume space which is separated into at least two, preferably two compartments.

In a preferred embodiment, the pouch of the invention is a dual-compartment pouch.

The pouch can be of any form, shape and material which is suitable to hold the composition, e.g. without allowing the release of the composition from the pouch prior to contact of the pouch to water. The exact execution will depend, for example, on the type and amount of the composition in the pouch, the number of compartments in the pouch, and on the characteristics required from the pouch to hold, protect and deliver or release the compositions.

The pouch may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load.

Another characteristic of the present invention is that the pouch is made from a water-soluble film which encloses an inner volume; said inner volume is divided into the compartments of the pouch.

The compartments of the pouch herein defined are closed structures, made from a water-soluble film which encloses a volume space which comprises the solid component or the liquid component of the composition. Said volume space is preferably enclosed by a water-soluble film in such a manner that the volume space is separated from the outside environment. The solid or liquid components that are comprised by the compartment of the pouch are contained in the volume space of the compartment, and are separated from the outside environment by a barrier of water-soluble film.

The term “separated” means for the purpose of this invention “physically distinct, in that a first ingredient comprised by a compartment is prevented from contacting a second ingredient if said second ingredient is not comprised by the same compartment which comprises said first ingredient”.

The term “outside environment” means for the purpose of this invention “anything which cannot pass through the water-soluble film which encloses the compartment and which is not comprised by the compartment”.

The compartment is suitable to hold the solid or liquid component, e.g. without allowing the release of the components from the compartment prior to contact of the pouch to water. The compartment can have any form or shape, depending on the nature of the material of the compartment, the nature of the components or composition, the intended use, amount of the components etc.

It may be preferred that the compartment which comprises the liquid component also comprises an air bubble, preferably the air bubble has a volume of no more than 50%, preferably no more than 40%, more preferably no more than 30%, more preferably no more than 20%, more preferably no more than 10% of the volume space of said compartment. Without being bound by theory, it is believed that the presence of the air bubble increases the tolerance of the pouch to the movement of liquid component within the compartment, thus reducing the risk of the liquid component leaking from the compartment.

The pouch is made from a water-soluble film; said water-soluble film typically has a solubility of at least 50%, preferably at least 75% or even at least 95%, as measured by the method set out hereinafter using a glass-filter with a maximum pore size of 50 microns.

Gravimetric method for determining water-solubility of the material of the pouch:

10 grams±0.1 gram of material is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the % solubility or dispersability can be calculated.

Preferred films are polymeric materials, preferably polymers which are formed into a film or sheet. The film can for example be obtained by casting, blow-moulding, extrusion or blow extrusion of the polymer material, as known in the art. Preferred polymers, copolymers or derivatives thereof are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC). Preferably, the level of polymer in the film, for example a PVA polymer, is at least 60%.

The polymer can have any weight average molecular weight, preferably from about 1000 to 1,000,000, or even form 10,000 to 300,000 or even form 15,000 to 200,000 or even form 20,000 to 150,000.

Mixtures of polymers can also be used. This may in particular be beneficial to control the mechanical and/or dissolution properties of the compartments or pouch, depending on the application thereof and the required needs. For example, it may be preferred that a mixture of polymers is present in the film, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-soluble.

It may be preferred that the polymer present in the film is from 60% to 98% hydrolysed, preferably 80% to 90%, to improve the dissolution of the material.

Most preferred are films which comprise a PVA polymer with similar properties to the film which comprises a PVA polymer and is known under the trade reference M8630, as sold by Chris-Craft Industrial Products of Gary, Ind., US.

The film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful when the pouched composition is a detergent composition, that the pouch or compartment material itself comprises a detergent additive to be delivered to the wash water, for example organic polymeric soil release agents, dispersants, dye transfer inhibitors.

The compartments and preferably pouch as a whole are made from water-soluble film. Suitable examples of commercially available water-soluble films include polyvinyl alcohol and partially hydrolysed polyvinyl acetate, alginates, cellulose ethers such as carboxymethylcellulose and methylcellulose, polyethylene oxide, polyacrylates and combinations of these.

Preferably, the water-soluble film of the pouch of the present invention comprises a polyvinyl alcohol polymer.

The pouch can be prepared according to methods known in the art. The pouch is typically prepared by first cutting an appropriately sized piece of pouch material, preferably the pouch material. The pouch material is then folded to form the necessary number and size of compartments and the edges are sealed using any suitable technology, for example heat sealing, wet sealing or pressure sealing. Preferably, a sealing source is brought into contact with the pouch material, heat or pressure is applied and the pouch material is sealed.

The pouch material is typically introduced to a mould and a vacuum applied so that the pouch material is flush with the inner surface of the mould, thus forming a vacuum formed indent or niche in said pouch material. This is referred to as vacuum-forming. Another suitable method is thermo-forming. Thermo-forming typically involves the step of forming an open pouch in a mould under application of heat, which allows the pouch material to take on the shape of the mould.

Typically more than one piece of pouch material is used for making multi-compartment pouches. For example, a first piece of pouch material can be vacuum pulled into the mould so that said pouch material is flush with the inner walls of the mould. A second piece of pouch material can then be positioned such, that it at least partially overlaps, and preferably completely overlaps, with the first piece of pouch material. The first piece of pouch material and second piece of pouch material are sealed together. The first piece of pouch material and second piece of pouch material can be made of the same type of material or can be different types of material.

In a preferred process, a piece of pouch material is folded at least twice, or at least three pieces of pouch material are used, or at least two pieces of pouch material are used wherein at least one piece of pouch material is folded at least once. The third piece of pouch material, or a folded piece of pouch material, creates a barrier layer that, when the sachet is sealed, divides the internal volume of said sachet into at least two or more compartments.

The pouch can also be prepared by fitting a first piece of the pouch material into a mould, for example the first piece of film may be vacuum pulled into the mould so that said film is flush with the inner walls of the mould. A composition, or component thereof, is typically poured into the mould. A pre-sealed compartment made of pouch material, is then typically placed over the mould containing the composition, or component thereof. The pre-sealed compartment preferably contains a composition, or component thereof. The pre-sealed compartment and said first piece of pouch material may be sealed together to form the pouch.

### Composition

The pouch comprises compositions; typically said compositions are contained in the volume space of the pouch. The compositions contained in the multi-compartment pouch are bleach additive composition which can be used to bleach fabrics in conjunction with a conventional granular or liquid laundry detergent.

Preferred compositions are laundry cleaning compositions or laundry fabric care compositions, preferably laundry compositions. Typically, the composition comprises such an amount of a cleaning composition, that one or a multitude of the pouched compositions is or are sufficient for one wash. An essential feature of the present invention is that the composition comprises a solid component and a liquid component. A first compartment comprises the solid component and a second compartment comprises the liquid component. It is important that the solid component and liquid component are separated by a water-soluble film.

### Solid Component

The solid component is comprised in a first compartment of the pouch. Said compartment is a different compartment to the compartment that comprises the liquid component.

An essential feature of the present invention is that the solid component of the pouch comprises a peroxide source in an amount of from 60 to 95% by weight of the composition.

Preferably the peroxide source will be present in an amount of from 60 to 95%, preferably from 65 to 85%, more preferably from 70 to 80% by weight of the solid component of the composition.

As used herein the expression “peroxide source” refers to any compound that produces perhydroxyl ions on contact with water. Suitable water-soluble sources of hydrogen peroxide for use herein include percarbonates, perborates and persilicates and mixtures thereof.

Preferred ingredient is a perhydrate bleach, such as salts of percarbonates, particularly the sodium salts, and/or organic peroxyacid bleach precursor. Inorganic perhydrate salts are a preferred source of peroxide.

Examples of inorganic perhydrate salts include percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilise a coated form of the material which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Alkali metal percarbonates, particularly sodium percarbonate are preferred perhydrates herein. Sodium percarbonate is an addition compound having a formula corresponding to 2Na₂CO₃-3H₂O₂, and is available commercially as a crystalline solid. Potassium peroxymonopersulfate is another inorganic perhydrate salt of use in the compositions herein.

In a more preferred embodiment, the source of peracid will be sodium percarbonate. The solid component of the composition will be an alkaline composition.

Said solid component preferably comprises (by weight of the solid component) at least 10%, more preferably at least 20%, more preferably at least 30% water-insoluble solid material. Preferably, said water-insoluble solid material includes water-insoluble building agents, preferably the water-insoluble building agent is an aluminosilicate, or water-insoluble fabric softening agent such as clay. Preferably, said water-insoluble solid material comprises a water-insoluble building agent. Preferred water-insoluble building agents are described in more detail hereinafter.

Another essential feature of the present invention is that the solid component of the pouch comprises a combination of two different polycarboxylated polymers.

As an essential feature, the laundry multi-compartment pouch of the present invention, comprise, in it solid component, a combination of two polymers, A and B.

The polymer A and B are present in a specific weight ratio. The weight ratio of polymer B to polymer A (the ratio polymer B/polymer A) is comprised between 0.033 and 30, preferably between 0.02 and 15, and the total polymer concentration is between 1 and 30% by weight of the solid component. Total polymer concentration is the sum of the weight concentration of polymer A and polymer B.

In another embodiment, the weight ratio of polymer B to polymer A (ratio polymer B-polymer A) is comprised between 30 and 50, preferably between 35-45 and more preferably is 40.

It is within this specific ratio that the product shows, at the same time, a good product stability and excellent flowability during processing.

The polymer A, according to the present invention, is an acrylic/sulphonic copolymer. In one embodiment, polymer A is an acrylic copolymer comprising polyacrylate or polycarboxylate. Typically, the polymer A is present in the solid phase of the pouch of the present invention.

The polymer A is present in an amount comprised between 1-30%, preferably in an amount comprised between 2 and 20% of the total weight of the powder composition.

In a preferred embodiment, the polymer A of the present invention has a molecular weight (Mw) comprised between 5 000 and 20 000, preferably comprised between 10 000 and 15 000. Typically the average molecular weight (Mw) of the polymer A is of about 12000.

The polymer A according to the present invention is a polycarboxylate copolymer. As used herein, “polycarboxylate” refers to compounds having a plurality of carboxylate groups, preferably at least 3 carboxylates.

Polycarboxylate builder can generally be added to the composition in acid form, but can also be added in the form of a neutralized salt or “over based”. When utilized in salt form, alkali metals, such as sodium, potassium, and lithium, or alkanolammonium salts are preferred. Useful polycarboxylates include homopolymers of acrylic acid and copolymers of acrylic acid and maleic acid.

Examples of such salts are polyacrylates and their copolymers with any suitable other monomer units including modified acrylic, furnaric, maleic, itaconic, aconitic, mesaconic, citraconic and methylenemalonic acid or their salts, maleic anhydride, acrylamide, alkylene, vinylmethyl ether, styrene and any mixtures thereof.

Preferred in the composition of the present invention is polycarboxylate utilized in salt form.

In a preferred embodiment, the polymer A is an acrylic copolymer. More preferably, the polymer A is an acrylic/sulphonic copolymer. In a preferred embodiment, the polymer A of the present invention is coated with silicate. Thus, in a more preferred embodiment, the copolymer sodium of the present invention is copolymer salt coated with an external silica coating.

Preferred polymers A, according to the present invention, are hydrophobically modified carboxylic acid polymers such as those available from Rohm & Haas, (Philadelphia, USA) under the trade name Acusol. Preferred polymer A is Acusol® 588 GF available from Rohm & Haas. Other useful polycarboxylate include the ether hydroxypolycarboxylates, copolymers of maleic anhydride with ethylene or vinyl methyl ether, 1,3,5-trihydroxy benzene-2,4,6-trisulfonic acid, and carboxymethyloxysuccinic acid, the various alkali metals, ammonium and substituted ammonium salts of polyacetic acids such as nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof. Suitable polycarboxylates are commercially available from Rohm & Haas under the trade name Norasol or Acusol.

Another essential ingredient of the composition of the present invention, is the polymer B. Typically, polymer B is present in the solid phase of the pouch of the present invention. The polymer B is present in an amount comprised between 1-30%, preferably in an amount comprised between 2 and 20% of the total weight of the powder composition.

The polymer B is a polymer according to formula I:

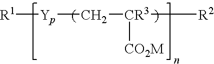

wherein Y is a comonomer or comonomer mixture selected from the group specified below; R¹ and R² are bleach- and alkali-stable polymer-end groups; R³ is H, OH or C₁₋₄ alkyl; M is H, alkali metal, alkaline earth metal, ammonium or substituted ammonium; p is not 0, up to 2; and n is at least 10, or mixtures thereof.

In the polymers herein, Y is selected from the group consisting of maleic acid, citraconic acid, itaconic acid, mesaconic acid and salts thereof, and mixtures thereof as the first monomer, and an unsaturated monocarboxylic acid such as acrylic acid or an alpha —C₁₋₄ alkyl acrylic acid as second monomer. Preferred polymers of this class are those according to formula I hereinabove, where Y is maleic acid. Also, in a preferred embodiment, R3 and M are H, and n is such that the polymers have a molecular weight of from 1000 to 400 000 atomic mass units, preferably of from 10 000 to 200 000, more preferably of from 30 000 to 70 000.

The alkali-stable polymer end groups R₁ and R₂ in formula I herein above suitably include alkyl groups, oxyalkyl groups and alkyl carboxylic acid groups and salts and esters thereof. In the above, n, the degree of polymerization of the polymer can be determined from the weight average polymer molecular weight by dividing the latter by the average monomer molecular weight. Thus, for a maleic-acrylic copolymer having a weight average molecular weight of 15,500 and comprising 30 moles % of maleic acid derived units, n is 182 (i.e. 15,500/(116×0.3+72×0.7).

In case of doubt, weight-average polymer molecular weights can be determined herein by gel permeation chromatography using Water [mu] Porasil® GPC 60 A² and [mu] Bondagel® E-125, E-500 and E-1000 in series, temperature-controlled columns at 40° C. against sodium polystyrene sulphonate polymer standards, available from Polymer Laboratories Ltd., Shropshire, UK, the polymer standards being 0.15M sodium dihydrogen phosphate and 0.02M tetramethyl ammonium hydroxide at pH 7.0 in 80/20 water/acetonitrile.

Highly preferred polymers for use herein are those in which n averages from 100 to 800, preferably from 120 to 400.

The dry-form compositions to be used herein comprise at least 50% by weight of said dry-form composition of a polymer as described hereinbefore, preferably at least 70%, most preferably at least 85%. By “dry”, it is meant herein that said dry-form composition comprising said polymer is substantially free of water.

Several such dry-form compositions are commercially available, for instance SOKALAN® CP45, CP5, CP7 and PA40 from BASF, and NORASOL SP02ND® from NORSOHAAS.

The dry bleaching compositions according to the present invention comprise from 1% to 30% by weight of the total composition of said dry-form composition, preferably from 5% to 20%. Preferably, the polymer B of the present invention is an acrylic acid/maleic acid copolymer available under the trade name SOKALAN® CP-5 from BASF. In a preferred embodiment the polymer B of the present invention have a molecular weight of from 20,000 to 100,000.

It may even be possible that part or all of the ingredients of the solid component are not pre-granulated, such as agglomerated, spray-dried, extruded, prior to incorporation into the compartment, and that the component is a mixture of dry-mixed powder ingredients or even raw materials. Preferred may be that for example less than 60% or even less than 40% or even less than 20% of the component is a free-flowable pre-granulated granule. Preferably the solid component is substantially solid in that at least 90%, preferably at least 95%, more preferably at least 98% of the ingredients comprised by the solid component are in a solid form. Preferably the solid component comprises ingredients that are either difficult or costly to include in a substantially liquid composition or that are typically transported and supplied as solid ingredients which require additional processing steps to enable them to be included in a substantially liquid composition.

### Liquid Component

The liquid component is comprised in a second compartment of the pouch. Said compartment is a different compartment to the compartment that comprises the solid component.

Preferably, the liquid component of the invention comprises surfactant. Typically the surfactant is a liquid at room temperature.

Preferably, the surfactant is a nonionic surfactant, an anionic surfactant or a combination thereof, most preferably the surfactant is a nonionic surfactant.

Preferably, said liquid component of the invention comprises a solvent or a perfume. Preferably, said liquid component comprises (by weight of the liquid component) at least 2%, more preferably at least 5%, more preferably at least 10%, more preferably at least 40% perfume.

Preferably, said liquid component comprises (by weight of liquid component) from 0.1% to 30%, more preferably from 5% to 25%, more preferably from 10% to 20% solvent. Preferably said solvent is an alcohol based solvent, more preferably said solvent is ethanol and/or n-butoxy propoxy propanol.

Preferably, the liquid component is substantially liquid in that at least 90%, more preferably at least 95%, more preferably at least 98% ingredients comprised by the liquid component are in a liquid form at room temperature.

The pouch of the present invention may also comprise other conventional ingredients commonly used in laundry composition, selected from the group comprising surfactants, building agents, chelating agents, dye, polymers, brighteners, enzymes, suds boosters, suds suppressors, perfumes, organic solvents and mixtures thereof. Preferably, the composition comprises at least one surfactant and at least one building agent. Unless otherwise specified, the components described herein can be incorporated either in the liquid component or in the solid component.

### Detersive Surfactants

In a preferred embodiment, the composition will contain detersive surfactants. These surfactants can be found either of the solid or in the liquid component. Preferably, surfactants herein are in liquid form and are comprised by the liquid component of the composition.

The surfactants are selected from the group consisting of nonionic surfactants, anionic surfactants, cationic surfactants, zwitterionic surfactants and/or amphoteric surfactants.

Preferably, the surfactants, according to the present invention surfactant, are nonionic surfactants, anionic surfactants or combination thereof. In a preferred embodiment the composition will comprise nonionic surfactant.

Even more preferably, the nonionic surfactants herein are in liquid form and are comprised by the liquid component of the composition.

Suitable anionic surfactants include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like. Exemplary surfactants are C₁₂-C₁₈ alkyl polyethoxylate (1.0) sulfate, C₁₂-C₁₈E (1.0)M), C₁₂-C₁₈ alkyl polyethoxylate (2.25) sulfate, C₁₂-C₁₈E(2.25)M), C₁₂-C₁₈ alkyl polyethoxylate (3.0) sulfate C₁₂-C₁₈E(3.0), and C₁₂-C₁₈ alkyl polyethoxylate (4.0) sulfate C₁₂-C₁₈E(4.0)M), wherein M is conveniently selected from sodium and potassium.

Other particularly suitable anionic surfactants for use herein are alkyl sulphonates including water-soluble salts or acids of the formula RSO₃M wherein R is a C₆-C₂₂ linear or branched, saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₂ linear or branched saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium, calcium, magnesium etc) or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

The alkylsulfonates and alkyl aryl sulphonates for use herein include primary and secondary alkylsulfonates and primary and secondary alkyl aryl sulphonates. By “secondary C₆-C₂₂ alkyl or C₆-C₂₂ alkyl aryl sulphonates”, it is meant herein that in the formula as defined above, the SO₃M or aryl-SO₃M group is linked to a carbon atom of the alkyl chain being placed between two other carbons of the said alkyl chain (secondary carbon atom).

For example C₁₄-C₁₆ alkyl sulphonate salt is commercially available under the name Hostapur® SAS from Hoechst and C₈-alkylsulphonate sodium salt is commercially available under the name Witconate NAS 8® from Witco SA. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright & Wilson.

Other anionic surfactants useful for detersive purposes can also be used herein. These can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁8 monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23 (herein incorporated by reference).

Particularly preferred surfactants are those selected from the group consisting of alkyl sulphate, alkyl sulphonate, alkyl ethoxy sulphate, alkyl benzene sulphonate, alkyl carboxylate, alkyl ethoxy carboxylate, amine oxides and mixtures thereof. More preferably the surfactant system comprises an alkyl sulphonate and an amine oxide.

Typically, the laundry additives according to the present invention preferably comprise the surfactant system at a level of from 0.01% to 30%, preferably from 0.1% to 15% and more preferably less than 10% and most preferably from 0.2% to 5% by weight of the laundry additive.

### Chelating Agents

The composition herein preferably comprises a chelating agent. The chelating agent can be either in the solid or in the liquid compartment. Preferably, the chelating agent will be in the solid phase.

Chelating agents are generally present at a level of from 1%, preferably from 2.5% from 3.5% or even 5.0% or even 7% and preferably up to 20% or even 15% or even 10% by weight of the composition herein.

By chelating agent it is meant herein components which act to sequester (chelate) heavy metal ions. These components may also have calcium and magnesium chelation capacity, but preferentially they show selectivity to binding heavy metal ions such as iron, manganese and copper.

The composition herein can comprise a chelating agent, for example, having two or more phosphonic acid or phosphonate groups, or two or more carboxylic acid or carboxylate groups, or mixtures thereof.

The laundry additive may comprise a chelating agent as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®. Polyfunctionally-substituted aromatic chelating agents may also be useful in the laundry additives herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Further carboxylate chelating agents to be used herein include salicylic acid, aspartic acid, glutamic acid, glycine, malonic acid or mixtures thereof.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid (HEDP), and mixtures thereof.

### Building Agent

The compositions in accordance with the present invention preferably contain a water-soluble builder compound, typically present in detergent compositions at levels of from 1% to 60% by weight, preferably from 3% to 40% by weight, most preferably from 5% to 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more that two carbon atoms, and mixtures of any of the foregoing.

Preferred builder compounds include citrate, tartrate, succinates, oxydissuccinates, carboxymethyloxysuccinate, nitrilotriacetate, and mixtures thereof.

Highly preferred maybe that one or more fatty acids and/or optionally salts thereof (and then preferably sodium salts) are present in the detergent composition. It has been found that this can provide further improved softening and cleaning of the fabrics. Preferably, the compositions comprise from 2% to 40%, more preferably from 5% to 30%, and most preferably 10% to 25% by weight of the composition of a fatty acid or salt thereof. Preferred are in particular C12-C18 saturated and/or unsaturated, linear and/or branched, fatty acids, but preferably mixtures of such fatty acids. Highly preferred have been found mixtures of saturated and unsaturated fatty acids, for example preferred is a mixture of rape seed-derived fatty acid and C16-C18 topped whole cut fatty acids, or a mixture of rape seed-derived fatty acid and a tallow alcohol derived fatty acid, palmitic, oleic, fatty alkylsuccinic acids, and mixtures thereof.

The compositions of the invention may comprise phosphate-containing builder material. Preferably present at levels of from 2% to 40%, more preferably from 5% to 30%, more preferably from 10% to 25%. Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid.

The compositions in accord with the present invention may contain a partially soluble or insoluble builder compound, typically present in detergent compositions at levels of from 0.5% to 60% by weight, preferably from 5% to 50% by weight, most preferably from 8% to 40% weight of the composition. Preferred are aluminosilicates and/or crystalline layered silicates such as SKS-6, available from Clariant. However, from a formulation point of view it may be preferred not to include such builders in the liquid composition, because it will lead to too much dispersed or precipitate.

### Radical Scavengers

The laundry additives of the present invention may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, are typically present herein in amounts up to 10% by weight of the total laundry additive and preferably from 0.001% to 0.5% by weight.

### Suds Controlling Agents

The laundry additives according to the present invention may further comprise a suds controlling agent such as 2-alkyl alkanol, or mixtures thereof, as a preferred optional ingredient. Particularly suitable to be used in the present invention are the 2-alkyl alkanols having an alkyl chain comprising from 6 to 16 carbon atoms, preferably from 8 to 12 and a terminal hydroxy group, said alkyl chain being substituted in the α position by an alkyl chain comprising from 1 to 10 carbon atoms, preferably from 2 to 8 and more preferably 3 to 6. Such suitable compounds are commercially available, for instance, in the Isofol® series such as Isofol® 12 (2-butyl octanol) or Isofol® 16 (2-hexyl decanol).

Other suds controlling agents may include alkali metal (e.g., sodium or potassium) fatty acids, or soaps thereof, containing from about 8 to about 24, preferably from about 10 to about 20 carbon atoms.

The fatty acids including those used in making the soaps can be obtained from natural sources such as, for instance, plant or animal-derived glycerides (e.g., palm oil, coconut oil, babassu oil, soybean oil, castor oil, tallow, whale oil, fish oil, tallow, grease, lard and mixtures thereof). The fatty acids can also be synthetically prepared (e.g., by oxidation of petroleum stocks or by the Fischer-Tropsch process).

Alkali metal soaps can be made by direct saponification of fats and oils or by the neutralization of the free fatty acids which are prepared in a separate manufacturing process. Particularly useful are the sodium and potassium salts of the mixtures of fatty acids derived from coconut oil and tallow, i.e., sodium and potassium tallow and coconut soaps.

Other suitable suds controlling agents are exemplified by silicones, and silica-silicone mixtures. Silicones can be generally represented by alkylated polysiloxane materials while silica is normally used in finely divided forms exemplified by silica aerogels and xerogels and hydrophobic silicas of various types. These materials can be incorporated as particulates in which the suds controlling agent is advantageously releasable incorporated in a water-soluble or water-dispersible, substantially non-surface-active detergent impermeable carrier. Alternatively the suds controlling agent can be dissolved or dispersed in a liquid carrier and applied by spraying on to one or more of the other components.

A preferred silicone suds controlling agent is disclosed in Bartollota et al. U.S. Pat. No. 3,933,672. Other particularly useful suds controlling agents are the self-emulsifying silicone suds controlling agents, described in German Patent Application DTOS 2 646 126 published Apr. 28, 1977. An example of such a compound is DC-544, commercially available from Dow Corning, which is a siloxane-glycol copolymer.

Especially preferred silicone suds controlling agents are described in Copending European Patent application N°92201649.8. Said laundry additives can comprise a silicone/silica mixture in combination with fumed nonporous silica such as Aerosil®.

A preferred type of suds controlling agent is an alkyl capped alcohol alkoxylate. The alkyl chain of the alcohol can be from C₃-C₃₀, the alkoxylate is preferably ethoxylate comprising preferably from 1 to 30 moles thereof and the cap is preferably a C₁-C₆ linear or branched alkyl group. Especially preferred suds controlling agent are the suds controlling agent system comprising a mixture of silicone oils and the 2-alkyl-alcanols.

Typically, the laundry additives herein may comprise up to 4% by weight of the total laundry additive of a suds controlling agent, or mixtures thereof, preferably from 0.1% to 1.5% and most preferably from 0.1% to 0.8%.

### Stabilisers

The laundry additives of the present invention may further comprise a stabiliser. Where present the stabiliser is present at a level of up to 10%, preferably from 2% to 4% by weight of the total laundry additive of an alcohol according to the formula HO—CR′R″—OH, wherein R′ and R″ are independently H or a C₂-C₁₀ hydrocarbon chain and/or cycle. Preferred alcohol according to that formula is propanediol. Indeed, we have observed that these alcohols in general and propanediol in particular also improve the chemical stability of the laundry additives.

Other stabilizers like inorganic stabilizers may be used herein. Examples of inorganic stabilizers include sodium stannate and various alkali metal phosphates such as the well-known sodium tripolyphosphates, sodium pyrophosphate and sodium orthophosphate.

### Suds Booster

If high sudsing is desired, suds boosters such as C₁₀-C₁₆ alkanolamides can be incorporated into the laundry additives, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, soluble magnesium salts such as MgCl₂, MgSO₄, and the like, can be added at levels of, for example, 0.1%-2%, to provide additional suds and to enhance grease removal performance.

### Suds Suppressing System

The composition may comprise a suds suppresser at a level less than 10%, preferably 0.001% to 10%, preferably from 0.01% to 8%, most preferably from 0.05% to 5%, by weight of the composition Preferably the suds suppresser is either a soap, paraffin, wax, or any combination thereof. If the suds suppresser is a suds suppressing silicone, then the detergent composition preferably comprises from 0.005% to 0.5% by weight a suds suppressing silicone. Suitable suds suppressing systems for use herein may comprise essentially any known antifoam compound, including for example silicone antifoam compounds and 2-alkyl alcanol antifoam compounds. Other suitable antifoam compounds include the monocarboxylic fatty acids and soluble salts thereof, as also described as builders above. These materials are described in U.S. Pat. No. 2,954,347, issued Sep. 27, 1960 to Wayne St. John. The monocarboxylic fatty acids, and salts thereof, for use as suds suppressor typically have hydrocarbyl chains of 10 to 24 carbon atoms, preferably 12 to 18 carbon atoms. Suitable salts include the alkali metal salts such as in particular sodium but also potassium salts.

### Optical Brightener

The laundry composition may optionally comprise an optical brightener. Where present the brightener is present at a level of from 0.005% to 5%, more preferably from 0.01% to 1%, most preferably from 0.01% to 0.5%.

The optical brighteners suitable for use in the present invention are substantially insoluble in water. Wherein substantially insoluble means that less than 1 gram of the brightener will dissolve in 1 liter of distilled water at pH 7. Nonionic brighteners, meaning those brighteners that do not have any permanently charged group or a group selected from sulphonic, sulphate, carboxylic, phosphonate, phosphate and quaternary ammonium.

In a preferred embodiment, the optical brightener is a substantially insoluble compound selected from compounds comprising stilbene, pyrazoline, coumarin, carboxylic acids, methinecyanines, dibenzothiophene-5,5-dioxide, azoles, 5- and 6-membered-ring heterocyclic, benzene or derivatives thereof and mixtures thereof. More preferably the brightener comprises a benzoxozol, pyrazole, triazole, triazine, imidazole, furan group or mixtures thereof.

Examples of preferred commerically available optical brighteners include those selected from the group consisting of Benzoxazole, 2,2′-(2,5-thiophenediyl)bis-(7CI, 8CI, 9CI) sold under the tradename Tinopal SOP (from Ciba-Geigy, C.I. Fluorescent Brightener 140 (9CI), 7-(dimethylamino)-4-methyl-2H-1-benzopyran-2-one (9CI) sold under the tradename Tinopal SWN (from Ciba-Geigy), Benzoxazole, 2,2′-(1,2-ethenediyl)bis[5-methyl-9CI) sold under the tradename Tinopal K (from Ciba-Geigy), C.I. Fluorescent Brightener 352 (9CI) 1H-Benzimidazole, 2,2′-(2,5-furandiyl)bis[1-methyl-(9CI) sold under the tradename Uvitex AT (from Ciba-Geigy).

### Perfume

Highly preferred are perfume components, preferably at least one component comprising a coating agent and/or carrier material, preferably organic polymer carrying the perfume or alumniosilicate carrying the perfume, or an encapsulate enclosing the perfume, for example starch or other cellulosic material encapsulate. The inventors have found that the perfumes are more efficiently deposited onto the fabric in the compositions of the invention.

Preferably the pouch compositions of the present invention comprise from 0.01% to 4% of perfume, more preferably from 0.1% to 2%.

### Enzymes

Another preferred ingredient useful in the compositions herein is one or more enzymes. Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase. Enzymes are generally incorporated in detergent compositions at a level of from 0.0001% to 2%, preferably from 0.001% to 0.2%, more preferably from 0.005% to 0.1% pure enzyme by weight of the composition. Furthermore, enzymes might be chemically or enzymatically modified, e.g. PEG-ylation, cross-linking and/or can be immobilized, i.e. enzymes attached to a carrier can be applied. The enzyme to be incorporated in a detergent composition can be in any suitable form, e.g. liquid, encapsulate, prill, granulate or any other form according to the current state of the art.

### Method of Treating Laundry

The present invention also relates to a method of treating laundry using a pouch. Preferably, the pouch is delivered into the washing machine by directly charging the drum of the washing machine with the pouch. The pouch is charged into the drum in view of being in a direct contact with the fabric to be treated.

As used herein, “the drum” refers to a washing basin/machine drum or to any system which allow the composition to be direct contact with the fabric prior the washing process of the washing machine. The use of the pouch into the drum is opposed to the use of the composition though a dispenser.

As used herein, “dispenser” refers to any system of withdrawing, removing, or channelling the composition of the present invention which introduce the compositions into the laundry process without being in contact with the fabric.

The method of treating laundry necessarily involves a washing step. The washing step according to the present invention is performed in a washing machine.

Fabrics to be treated herein include, but are not limited to, clothes, curtains, drapes, bed linens, bath linens, tablecloths, sleeping bags and/or tents. By “treating a fabric”, it is meant herein cleaning said fabric.

The process of washing fabrics according to the present invention may comprise the steps of diluting, dissolving or dispersing the composition in a bath of wash water.

By “diluted, dissolved or dispersed” it is meant herein, that at least 50%, preferably at least 80%, more preferably at least 90%, even more preferably at least 95%, still more preferably at least 98%, and most preferably at least 99%, of said conventional laundry detergent are diluted, dissolved or dispersed in the aqueous bath formed in the process according to the present invention.

The term “bath” as used herein to define any suitable receptacle for the water. Such a receptacle may for example be a bath tub or a bucket. Alternatively, the receptacle may be a washing machine.

According to the process of the present invention, a conventional detergent composition can be charged to the washing machine by way of the dispenser drawer of the washing machine or by directly charging the drum of the washing machine. The pouch is loaded directly into the drum of the washing machine. Preferably the conventional laundry detergent and the sachet are both directly placed into the drum of the washing machine.

By “conventional laundry detergent” it is meant herein, a laundry detergent composition currently available on the market. Preferably, said conventional laundry detergent comprises at least one surfactant. Said laundry detergent compositions may be formulated as powders, liquids or tablets. Suitable laundry detergent compositions are for example DASH Futur®, DASH Liquid®, ARIEL Tablets® and other products sold under the trade names ARIEL® or TIDE®.

### Example 1

A piece of plastic is placed in a mould to act as a false bottom. The mould consists of a cylindrical shape and has a diameter of 45 mm and a depth of 25 mm. A 1 mm thick layer of rubber is present around the edges of the mould. The mould has some holes in the mould material to allow a vacuum to be applied. With the false bottom in place the depth of the mould is 12 mm. A piece of Chris-Craft M-8630 film is placed on top of this mould and fixed in place. A vacuum is applied to pull the film into the mould and pull the film flush with the inner surface of the mould and the false bottom. 5 mL of the liquid component of a detergent composition is poured into the mould. Next, a second piece of Chris-Craft M-8630 film is placed over the top of the mould with the liquid component and sealed to the first piece of film by applying an annular piece of flat metal of an inner diameter of 46 mm and heating that metal under moderate pressure onto the ring of rubber at the edge of the mould to heat-seal the two pieces of film together to form a compartment comprising the liquid component. The metal ring is typically heated to a temperature of from 135° C. to 150° C. and applied for up to 5 seconds.

The compartment comprising the liquid compartment is removed from the mould and the piece of plastic acting as a false bottom is also removed from the mould. A third piece of Chris-Craft M-8630 film is placed on top of the mould and fixed in place. A vacuum is applied to pull the film into the mould and pull the film flush with the inner surface of the mould. 40 g of the solid component of the detergent composition is poured into the mould. Next, the compartment comprising the liquid component is placed over the top of the mould with the solid component and is sealed to the third layer of film by applying an annular piece of flat metal of an inner diameter of 46 mm and heating that metal under moderate pressure onto the ring of rubber at the edge of the mould to heat-seal the pieces of film together to form a pouch comprising two compartments, where a first compartment comprises the liquid component of the detergent composition and a second compartment comprises the solid component of the detergent composition. The metal ring is typically heated to a temperature of from 135° C. to 150° C. and applied for up to 5 seconds.

### Example 2

Following pouches were made by the process described in example I. each pouches comprise the following liquid component and solid component. The compositions were made by mixing the listed ingredients in the listed proportions (weight % are expressed by weight of each component (solid/liquid) and by weight of the total product).

| Ingredient | % in phase | % in F.P. | |
|---|---|---|---|
| Percarbonate | 74.9 | 64.369 | |
| Polymer B | 7.5 | 6.446 | |
| Polymer A | 13 | 11.172 | |
| Blend Savinase- Natalase | 2.1 | 1.805 | |
| FN3 D3 | 0.9 | 0.773 | |
| HEDP Granular | 1.5 | 1.289 | |
| Perfume | 0.1 | 0.086 | |
| total powder phase | 100.00 | | 85.94% |
| 630 mm M8630K PVA Film | 100.00 | 1.2 | 1.2% |
| DPG | 57.29 | 5.970 | |
| Glycerine | 2.99 | 0.312 | |
| Acid Blue 80 | 0.9 | 0.094 | |
| LF244 | 29.47 | 3.071 | |
| Neodol | 2.63 | 0.274 | |
| Water | 6.72 | 0.700 | |
| total liquid phase | 100.00 | | 10.42% |
| M8630K PVA Film | 100.00 | 2.44 | 2.44% |

### Abbreviations Used in Examples

In the examples, the abbreviated component identifications have the following meanings:

Polymer A Polyacrylate or polycarboxylate
Polymer B Acrylic Acid/Maleic Acid copolymer
HEDP (Chelating agent) Ethane 1-hydroxy-1,1-diphosphonic acid
Percarbonate (Bleach) Sodium percarbonate (2Na₂CO₃.3H₂O₂)
Savinase Protease available from Novozyme
Natalase α-amylase available from Novozyme
FN3 protease available from Genencor
DPG (Solvent) dipropylene glycol

### Acid Blue 80 dye

LF244® Surfactant from Croda
Neodol® Nonionic Surfactant from Shell

The pouch is introduced in the DRUM compartment of a Bosch Siemens 6032 dishwashing machine, the dispenser is closed and the washing machine operated in its normal 55° C. program.

### Example 3

### Hygroscopy and Flowability measurement

a. Hygroscopy Measurement

Storage conditions: The pouches coming from example 2 are kept in climatic chamber under controlled temperature and moisture to let the product to adsorb water from the environment. Combination of temperature and moisture is chosen as convenience, to let the product adsorb enough moisture, combinations could be 25° C./50% rH, 32° C./80% rH 35° C./50% rH, 40° C./80% rH, etc.

Product preparation: The pouches are poured into Petri dishes and placed in the climatic chamber set as above. The products stay there for at least 1 hour. After the water intake step, the samples are removed from the chamber and let stayed at room condition for 30 minutes before the hygroscopicity is measured. The measurement of hygroscopicity is made by weight loss (gravimetric), method wheel established for the skilled person. For the gravimetric weight loss, the temperature (i.e. 80° C.) and the time (i.e. 10 min) are set as convenient to avoid chemical decomposition.

b. Flowability Measurement

Assessment of the amount of pouring in a granular laundry composition is evaluated by visual assessment.

The scale ranges from 0 to 10 with Scale 0 being that there is no flow at all and with Scale 10 being that the composition flow like water.

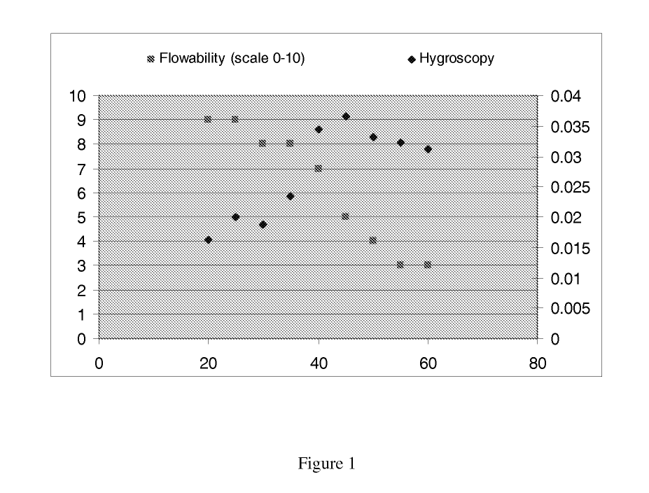

The results of the Hygroscopy and Flowability measurement are illustrated in Table 1 and in FIG. 1.

TABLE 1

| Ratio | Hygroscopy | Flowability |
|---|---|---|
| Polymer B/Polymer A | (in %) | (scale 0-10) |
| 0.033 | 0.0094 | 10 |
| 0.050 | 0.0110 | 10 |
| 1 | 0.0136 | 10 |
| 5 | 0.0144 | 9 |
| 10 | 0.0149 | 9 |
| 20 | 0.0163 | 9 |
| 25 | 0.02 | 9 |
| 30 | 0.0187 | 8 |

Polymer A is polyacrylate available from Rohm & Haas.
Polymer B is Acrylic Acid/Maleic Acid copolymer available from BASF.
Measured using a Rotronic Hygrolab

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry multi-compartment pouch made from a water-soluble film and having at least two compartments, said multi-compartment pouch comprises a composition comprising a solid component and a liquid component, wherein the solid component contains:
(i) from about 60% to about 95% of a peroxide source;
(ii) from about 1% to about 30% of a polymer A which is an acrylic copolymer comprising polyacrylate or polycarboxylate;
(iii) from about 1% to about 30% of a polymer B which is according to formula I: 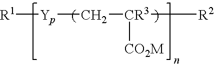
wherein Y is a comonomer or comonomer mixture selected from the group consisting of maleic acid, citraconic acid, itaconic acid, mesaconic acid and salts thereof and mixtures thereof as the first monomer, and an unsaturated monocarboxylic acid such as acrylic acid or an alpha —C₁₋₄ alkyl acrylic acid as second monomer; R¹ and R² are bleach- and alkali-stable polymer-end groups; R³ is H, OH or C₁₋₄ alkyl; M is H, alkali metal, alkaline earth metal, ammonium or substituted ammonium; p is not 0, up to 2; and n is at least 10, or mixtures thereof.
wherein, the weight ratio of polymer B to polymer A is comprised between about 0.033 and about 30, and the total polymer concentration is between about 1% and about 30% by weight of the solid component.

2. The multi-compartment pouch according to claim 1 wherein the polymer A is acrylic/sulphonic copolymer, preferably coated with silicate.

3. The multi-compartment pouch according to claim 1 wherein polymer A has a molecular weight comprised between about 5 000 and about 20 000.

4. The multi-compartment pouch according to claim 1 wherein polymer B has the formula I, and wherein R³ and M are H.

5. The multi-compartment pouch according to claim 1 wherein polymer B has a molecular weight of from about 1 000 to about 400 000 atomic mass units.

6. The multi-compartment pouch according to claim 1 wherein the solid component composition comprises a peroxide source in an amount of from about 65% to about 85% by weight of the solid component of the composition.

7. The multi-compartment pouch according to claim 6 wherein the solid component comprises sodium percarbonate as peroxide source.

8. The multi-compartment pouch according to claim 1 wherein the liquid component of the pouch comprises a surfactant, whereby said surfactant is a nonionic surfactant, an anionic surfactant or a combination thereof.

9. The multi-compartment pouch according to claim 1 wherein the solid component of the pouch comprises a chelating agent.

10. The multi-compartment pouch according to claim 1 wherein the water-soluble film material of the pouch is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose and mixtures thereof.

11. The multi-compartment pouch according to claim 10 wherein the water-soluble film of the pouch comprises a polyvinyl alcohol polymer.

12. The multi-compartment pouch according to claim 1 wherein the pouch is a dual-compartment pouch.

13. The multi-compartment pouch according to claim 1 wherein the composition further comprises ingredients selected from the group comprising surfactant, dye, polymers, brighteners, enzymes, suds boosters, suds suppressors, perfumes and mixtures thereof.

14. A method of treating fabrics by placing the pouch, according to claim 1, in the drum of a washing machine.
